(19) United States
(12) Patent Application Publication
(10) Pub. No.: US 2013/0224279 A1
(43) Pub. Date: Aug. 29, 2013

(54) PROCESS FOR THE PREPARATION OF CALCIUM SALT SUSPENSIONS

(71) Applicants: Gustavo Eduardo Bolanos Barrera, Cali (CO); Isabel Maria Mejia Villareal, Cali (CO)

(72) Inventors: Gustavo Eduardo Bolanos Barrera, Cali (CO); Isabel Maria Mejia Villareal, Cali (CO)

(73) Assignee: UNIVERSIDAD DEL VALLE, Santiago de Cali (CO)

(21) Appl. No.: 13/876,071

(22) PCT Filed: Dec. 8, 2010
(86) PCT No.: PCT/IB10/55652

§ 371 Date: May 16, 2013

(30) Foreign Application Priority Data
Nov. 19, 2010 (CO) 10145132

(51) Int. Cl. A23L 1/304; A23C 9/152; A23L 2/52

(52) U.S. Cl. CPC A23L 1/304; A23L 2/52; A23C 9/1522
USPC 424/439; 514/574; 424/687; 426/474

(57) ABSTRACT

The current invention is related to a novel process for the production of aqueous suspensions of micro and nanoparticles of calcium salts smaller than 10 μm particle size, along with a method to enrich nutritional, nutraceutical, and pharmaceutical beverages with calcium salts. In the process, an aqueous suspension of calcium salt is subjected to pressurization with critical, subcritical, or supercritical carbon dioxide to increase the solubility of the calcium salt, which has a particle size greater than 30 μm. The resulting solution is expanded through a nozzle to generate a calcium salt suspension of micro and nanoparticles that is imperceptible to sight and taste.

### SUMMARY OF THE INVENTION

The current invention is related to a novel process for the production of aqueous suspensions of micro and nanoparticles of calcium salts smaller than 10 μm particle size, along with a method to enrich nutritional, nutraceutical, and pharmaceutical beverages with calcium salts. In the process, an aqueous suspension of calcium salt is subjected to pressurization with critical, subcritical, or supercritical carbon dioxide to increase the solubility of the calcium salt, which has a particle size greater than 30 μm. The resulting solution is expanded through a nozzle to generate a calcium salt suspension of micro and nanoparticles that is imperceptible to sight and taste.

### FIELD OF THE INVENTION

The current invention is related to a novel process for the reduction of particle size of aqueous suspensions of calcium salts via pressurization techniques with critical, subcritical, or supercritical carbon dioxide, which permit increasing the solubility of the calcium salt, as well as a method to enrich nutritional, nutraceutical, and pharmaceutical beverages with calcium salts.

### BACKGROUND OF THE INVENTION

In the nutritional beverage industry, there is a constant need to obtain concentrated, enriched formulations in carbonate, lactate, or dry calcium citrate, in solution or suspension, that remain stable for prolonged periods and that are easily re-dispersed on the medium for the purpose of satisfying world demand of nutritional liquids (juices, milks, and water) reinforced with minerals, destined to preventing osteoporosis and increasing physical capacity and body performance, and, consequentially, generalized recognition of the benefits associated to the continuous consumption of foods enriched with trace elements like calcium.

In consideration of the therapeutical application of concentrates enriched with calcium, the treatment of diseases like osteopenia and osteoporosis is based on ingesting calcium-reinforced supplements, of which the most common is calcium carbonate. However, it is known that calcium citrate administered orally supplies a greater quantity of bio-absorbable calcium than an equivalent amount from calcium carbonate salt.

In fact, in the prior art related to the application of calcium salts for the manufacture of enriched beverages, there are publications like the patent document U.S. Pat. No. 3,965,273, which details a method for the preparation of dry concentrates of carbonated salts. The document establishes that conventionally, dry sodium or potassium carbonates, as well as ammonium or potassium bicarbonates have been used to enrich beverages (Diller, U.S. Pat. No. 2,851,359); nevertheless, in the state of the technique there is a need to improve the palatability of the beverages; for this reason the use of calcium carbonate is only reported in combination with other carbonates.

The application of calcium carbonate salt has also resulted troublesome because of its low solubility and the prolonged periods required to reach its dissolution. Additionally, commercial-grade carbonates liberate sediments whose particle sizes vary between 30 and 40 μm. To solve this problem, the referenced publication U.S. Pat. No. 3,965,273, presents a method to increase the solubility of the calcium carbonate particles through the injection of carbon dioxide into acid solutions by managing the pH; thus, avoiding the generation of suspensions and overcoming problems associated with these types of systems in which the carbonate particles tend to aggregate and the compacted sediments turn out difficult to dissolve.

According to the document, the rate of the reaction depends on the exposed surface area of the calcium carbonate particles and the amount of dioxide injected must remain under minimum intensity and duration to avoid the formation of CO₂ in solution and to accomplish re-dispersion/dissolution of the concentrate; for this reason the method must be completely carried out at temperatures below 0° C.

Nevertheless, according to the document the amount of dioxide extensively and intensively injected does not ensure the solvation effect of the sediments in the events producing the formation of suspensions and it also does not recur to the use of salts that present a greater percentage of absorption and use at the physiological level as is the case of calcium citrate.

Other documents revealed by the state-of-the-art and related with methods to reduce particle size of solids, based mainly on adding fluids in critical, subcritical, and supercritical state at determined pressure and temperature but without specific application in the nutrients field are mentioned hereinafter:

Patent document U.S. Pat. No. 5,921,478 reveals an efficient method for fine dispersion of a solid material by using the physical-chemical characteristics of a supercritical fluid. Dispersed solids include ultrafine particles like pigments, powder from ceramic material, or magnetic particles. Examples of the patent mentioned show a comparative experiment of the efficient dispersion method, detailed therein, against other conventional methods using carbon dioxide as supercritical solvent and a dispersion of carbon black in water at 2%. The process comprises the stages of: feeding a mixture of a solid or a dispersed liquid onto an organic solvent or water in a tank and feeding the tank with a supercritical solvent, to then heat and compress the mixture producing the conversion of the supercritical solvent from gaseous state to supercritical fluid, thus, obtaining a mixture of reduced viscosity. Thereafter, the fluid and the supercritical mixture are introduced into a rupture tank liberating the supercritical mixture at atmospheric pressure to generate a volume expansion effect and, via the collision effect with a zone of the tank, generate the dispersion effect of the solid to recover the dispersed solid in a deareator tank and the supercritical solvent through a tank that includes a filter and a compression pump.

The patent publication WO2004/050251 shows a process to achieve molecular reordering and the reduction of the mean diameter of the particles of inorganic solids like aluminum oxides or hydroxides, natural or synthetic clays, silica minerals, magnesium sources like magnesium oxides or hydroxides, zirconium compounds, titanium oxides or hydroxides, catalysts, or catalyst precursors. The method consists in that during the first stage there is a flow of an initial suspension of particles with average diameter between 1 and 1000 μm and viscosity between 1 and 500 Pa.s in a non-supercritical solvent selected among: water, methanol, ethanol, propanol, isopropanol, toluene, hexane, or gasoline through a series of conversion tanks that reduce particle size to intermediate levels. The second stage of the method consists in adding carbon dioxide in supercritical state to one or more of the conversion tanks forming a supercritical suspension. The third stage consists in diminishing the pressure of the supercritical suspension, expanding the suspension and converting the intermediate particles into particles with a mean diameter below 1 μm. Diminishing of the pressure is preferably carried out by spraying the suspension through a nozzle or vent on the tank, in a process denominated rapid expansion of supercritical suspensions, which is greatly influenced by the nozzle temperature, because only this way can avoid freezing through cooling, along with particle compacting. Nevertheless, this document does not furnish evidence on the application of this method for the preparation of beverages enriched with calcium salts and their development, through the determination of the physiochemical conditions related to the process.

Another related document is revealed by the patent publication JP2003200077, but it is destined to the design of an apparatus that permits increasing the purity of fine solids and increasing efficiency in the fabrication process of products presenting solubility deficiency. This document recurs to the injection of a mixture of liquefied carbon dioxide in supercritical state and a solvent, which facilitates dissolution of the materials.

Patent publication RU2356609 reveals a method to reduce particle size for the fabrication of aerosols and powders without recurring to organic solvents, by pouring an aqueous solution of a micronized substance into a high-pressure cell through a high-pressure pump that receives carbon dioxide until keeping the pressure in the range from 90 to 400 atm and temperature in a range from 22 to 160° C. The two-phase system obtained, i.e., the substance/CO₂ aqueous solution is dispersed through a nozzle under temperature ranging between 100 and 200° C. The supercritical CO₂ acts as a plunger and the nano and micro particles formed in the dispersion chamber are trapped in a separator system. Through this methodology, it is possible to obtain nano- and micro-sized substances soluble in water; and the differences with respect to the process described in the present invention lie in that the physicochemical requirements of the process claimed are minor, given that the pressure required while adding supercritical or subcritical CO₂ reaches 100 to 1800 psi (6.8-122.4 atm) and temperatures ranging between 10 and 40° C., which permits obtaining a fixed particle size between 2 and 10 μm; while for the case of the Russian publication higher temperature and pressure are required.

Likewise, patent CN101444709 offers a device and a method to obtain solid particles from an aqueous solution by employing supercritical CO₂. The device comprises a CO₂ transport mechanism, a transport mechanism for the aqueous solution, a mechanism to gather and recycle the particles, and a control mechanism. Nonetheless, within the requirements of the process there are: the selection of a soluble material, a moisturizer, and water prepared in a high-pressure system to then be transported through passing a two-way nozzle; thereby, not resulting applicable to micronizing inorganic salts lightly soluble or incompatible with moisturizing agents. The CO₂ is transported through a second passing of a coaxial nozzle to reach the supercritical fluid state. The solution of the material soluble in water, the moisturizer, and the water are atomized and the solid particles are collected in a chamber that permits recovery of the particles, while the moisturizer and the aqueous solution are dragged by the CO₂.

Regarding the methods for the production of citrate-type calcium salts for the fabrication of nutritional products, the state-of-the-art describes the following patent documents U.S. Pat. No. 7,323,201, U.S. Pat. No. 7,267,832, U.S. Pat. No. 6,740,344, and U.S. Pat. No. 6,261,610. According to these publications, the calcium salt is used in polymorphic forms and in the form of tricalcium citrate given their greater solubility in aqueous medium or as in the case of document U.S. Pat. No. 7,267,832 in the form of calcium citrate in amorphous form through the calcium hydroxide, calcium oxide, or calcium carbonate reaction with citric acid in aqueous solution at 10° C. to form amorphous calcium citrate. In other instances, other methods are described for the fabrication of a fortified product in calcium phosphate for daily consumption through enriching pasteurized milk by heating to temperatures between 40 and 60° C., and adding an excess of calcium phosphate powder with a mean diameter below 6 μm or through the combination of a hydroxide-type calcium salt and a magnesium salt with lactic acid and citric acid to obtain a mixture of the salts destined to enriching fortified products in the form of meta-stable citrate-lactate calcium-magnesium complexes. In the case of these processes, there is no application of any known methodologies in the nutrition field to reduce particle size and much less to adding supercritical fluids.

Consequently and according to the state-of-the-art closer to matter claimed, the supercritical fluids have only been the object of application in the field of fabrication of pigments, powder from ceramic material or magnetic particles, aluminum oxides or hydroxides, natural or synthetic clays, silica minerals, magnesium oxides or hydroxides, zirconium compounds, titanium oxides or hydroxides, catalysts or their precursors, without evidence of the application of a novel method like the one claimed for the fabrication of beverages enriched with calcium salts, particularly citrate-type, and their development, through the determination of the physiochemical conditions related to the process.

Although there are methodologies to enrich nutritional beverages, among them lacteous types, and procedures designed to obtain polymorphic or amorphous forms of calcium citrate salt or its complexes, to increase the dissolution rate of the salts in the medium, none of these methodologies has managed to diminish the degree of aggregation and caking generated in the nutritional formulations, which has resulted perceptible to product consumers because of the difficulty of dispersing the sediment within the system.

As has been pointed out, an important technical limitation for the fabrication of calcium-reinforced nutritional products lies in that the organic or inorganic salts of this oligoelement (dietary mineral) are not very soluble in water (for example, 0.85 g/l for calcium citrate and 0.012 g/l for calcium carbonate) and added to this fact, calcium salts, especially carbonate-type calcium salts, present reduced bio-availability because of the absorption changes associated with age and changes in the skeletal growth; hence, calcium requirements throughout life are not uniform and the body in advanced age only incorporates onto the organism a small percentage of the dosage of calcium administered, through dietary intake or from nutritional supplements, for this reason it has become a determinant factor that during the manufacture process of enriched beverages in trace elements like calcium, the particle size will be reduced to the micron level (<30 μm) to ensure their permanence in the product and their absorption.

The innovative methodology of the present patent application facilitates the permanence of the trace element in the system in suspension form in enriched lacteous beverages or in juices, without their being perceptible by the consumer or without diminishing the palatability of the beverage and without need to recur to conventional methods of milling the calcium salt or modifying its polymorphic or amorphous forms, processes that consume a high amount of energy and generate meta-stable solids that modify their behavior through time.

Currently, the industry of calcium-enriched nutritional beverages requires salts with particle sizes below 5 μm. This is due to the growing demand for products that remain stable for prolonged periods of time and that are subjected to varying temperature and humidity conditions, with greater amount of bio-available calcium.

And because of the deficient stability of the products, consumers can detect the presence of dispersed particles that in most instances correspond to calcium salts that become perceptible to the senses in the form of sandy sediments within the nutritional beverage when the particle size is above the 30 μm limit.

The increase of particle size by aggregation of the sediments brings the formation of caking within relatively short periods, and although with particle size around 8 μm consumers can hardly detect the presence of the solid, there is still the technical problem associated to sedimentation of the solid. This situation leads to the loss of the product's nutritional value because the sedimented calcium is poorly exchanged with the calcium in solution, which consequently brings a notable decrease in calcium absorption levels by the organism, along with palatability problems given the consumer's detection of the particulate material, this time as a sludge residue in the bottom of the container.

The process of the present invention overcomes technical limitations associated to conventional processes for reducing particle size, which recur to milling techniques to produce calcium salts with particle size below 5 μm. Such is the case of the high power consumption, accumulation of static load, and excessively high costs to reach particle sizes near 5 μm.

Other advantages derived from the design of the process object of the invention lie in that it does not require the use and application of toxic or flammable substances and that it is possible to manage the biological requirements of the process even under sterility conditions. Additionally, the process claimed allow reducing the particle size while it exerts effective control on the size distribution and its implementation does not require high investment costs, bearing in mind that the purpose of reinforcing nutritional beverages with calcium consists of producing aqueous suspensions of calcium salt micro and nanoparticles.

Hence, with the novel process claimed an aqueous suspension of the calcium salt with particle size above 30 μm is subjected to pressurization with critical, subcritical, or supercritical carbon dioxide to increase the solubility of the calcium salt. Then, the resulting solution is expanded through a nozzle to generate a suspension of calcium salt micro and nanoparticles, which is imperceptible to sight and taste; hence, during sensory analysis of the product it is evident that consumers prefer enriched beverages with calcium particles in sizes below 5 μm.

The increase in the solubility of the calcium salts obtained with the process reaches levels to 200%, while the reduction of particle size 99.95% effective. The increased solubility of the calcium salts, as well as the reduced particle size is accomplished at moderate temperatures and pressures with a process of easy industrial implementation that guarantees sterile conditions. Including without the use of stabilizers or moisturizers within the particle size reduction process, the calcium salt suspensions obtained are stable for several months with or without refrigeration, complying with international standards of stability for nutritional products. Additionally, the process object of the current patent application can be applied in diverse fields of the nutritional, nutraceutical, and pharmaceutical industry for calcium enrichment of carbonated beverages, water, fruit juice, lacteous beverages, soups, and liquid nutrients for nutritional support.

### BRIEF DESCRIPTION OF THE FIGURES

FIG. 1 shows a schematic representation of the continuous process of the invention in batch mode for the production of aqueous suspensions of calcium salt micro and nanoparticles.

FIG. 2 shows a schematic representation of the continuous process of the invention for the production of aqueous suspensions of calcium salt micro and nanoparticles.

FIG. 3 presents a particle size distribution graphic of the calcium citrate salt under depressurization conditions: 1.1 mg/ml, 15° C., 750 psig.

FIG. 4 presents a particle size distribution graphic of the calcium citrate salt under depressurization conditions: 1.1 mg/ml, 22.5° C., 750 psig.

FIG. 5 shows a particle size distribution graphic of the calcium citrate salt under depressurization conditions: 1.1 mg/ml, 30° C., 900 psig.

FIG. 6 presents a particle size distribution graphic of the calcium citrate salt under depressurization conditions: 1.1 mg/ml, 30° C., 1500 psig.

FIG. 7 shows a particle size distribution graphic of the calcium citrate salt under depressurization conditions: 1.6 mg/ml, 22.5° C., 750 psig.

### OBJECTS OF THE INVENTION

In a first objective, the invention is related to a process for the production of aqueous suspensions of calcium salt micro and nanoparticles with sizes below 10 μm through pressurization with critical, subcritical, or supercritical carbon dioxide.

In a second objective, the invention describes a method for incorporating calcium salts with particle size below 10 μm in water, carbonated beverages, juices, lacteous beverages, soups, or any other types of nutritional, nutraceutical, or pharmaceutical beverages without altering the organoleptic properties of the beverages.

### DETAILED DESCRIPTION OF THE INVENTION

In a first objective, the invention details a process to prepare an aqueous suspension of calcium salt particles with a particle size below 10 μm, comprising three stages:

a) Add compressed carbon dioxide in subcritical, critical, or supercritical state to a calcium salt suspension with particle size above 30 μm in a container at a pressure between 6.8 and 122.4 atmospheres and temperature between 10 and 40° C. for a period of time ranging from 0.5 to 2 h; where carbon dioxide diminishes the water pH and increases the solubility of the calcium salt in water.

b) Transfer the compressed solution through a nozzle with a diameter between 50 and 150 μm and lengthy from 0.25 to 6 mm, where the depressurization generates micro or nanoparticles of the calcium salt in suspension in the aqueous medium. Said decompression is carried out at constant temperature and pressure or equal to solubility conditions to avoid possible precipitations of the particles and consequent clogging of the nozzle.

According to the invention, increase of calcium salt solubility in aqueous solutions can be achieved by bringing together an aqueous suspension of the calcium salt with carbon dioxide under critical, subcritical, or supercritical conditions at temperatures between 10 and 45° C. and pressures between 100 and 2000 psig and even higher, given that carbon dioxide diminishes water pH and increases the solubility of the calcium salt in water.

The process is applicable to different calcium salts used as nutritional additives for humans and animals, as well as for other industrial uses; including but not limited to the following salts: acetate (C₄H₆CaO₄), aspartate (C₄H₁₀CaClNO₆), chloride (CaCl₂), citrate (C₁₂H₁₀Ca₃O₁₄), stearate (C₃₆H₇₀CaO₄), phosphate (Ca₃(PO₄)₂), fumarate (C₄H₂CaO₄), glycerophosphate (C₃H₇CaO₆P), gluceptate (C₁₄H₂₆CaO₁₆), gluconate (C₁₂H₂₂CaO₁₄), lactate (C₆H₁₀CaO₆), and malate (C₄H₄CaO₅), among others.

The decompression carried out in stage (b) to atmospheric pressure is conducted suddenly through a small diameter (50 to 150 μm) nozzle with a length from 0.25 to 6 mm, causing high super-saturation in fractions of a second, but limiting the time required for significant size growth of the particles. Within the scope of the invention, said depressurization is performed at constant temperature and pressure and equal to solubility conditions to avoid possible precipitation of the particles and the consequent clogging of the nozzle.

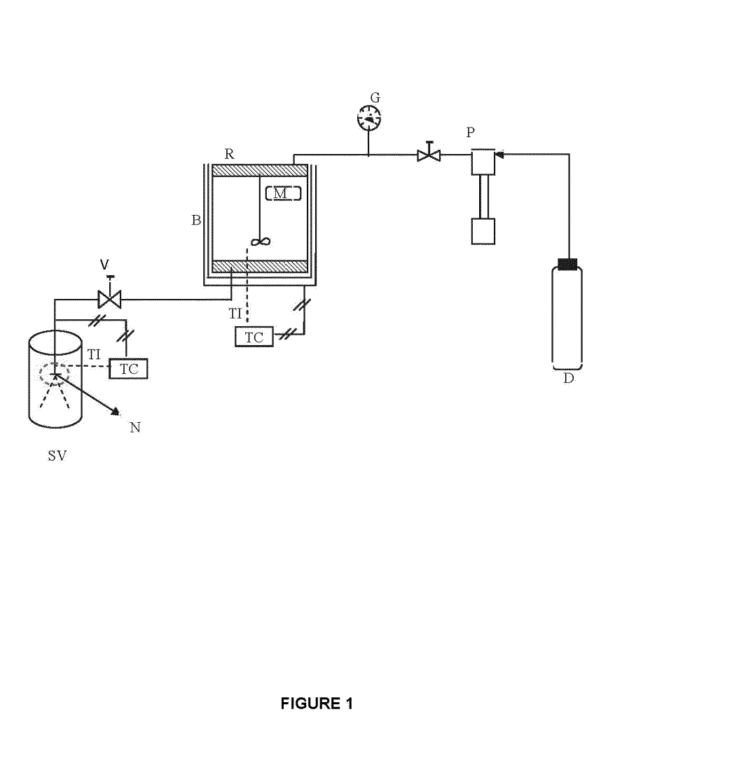

FIG. 1 presents a schematic representation of the process of the invention conducted in batch mode where a calcium salt suspension in the liquid that is to be reinforced with calcium is loaded onto a high-pressure container (R), which is coated (B), to keep the temperature constant (TC) (for example, 15° C.). The contents of the container are kept in agitation and under visual observation through a high-pressure peephole (M). The system is loaded with carbon dioxide from a cylinder (D) through a high-pressure pump (P) (for example, up to 6,62 MPa) regulating flow by using one or more ball valves (V). A waiting period is given to reach equilibrium (for example, between 0.5 and 2 h), keeping pressure and temperature constant through monitoring with a manometer (G) and a thermocouple (TI), at the end of which the calcium salt is completely solubilized.

Once the calcium salt solubility is reached, the pressure can continue to increase to ensure its complete solubility. Nonetheless, the invention is susceptible to being implemented at greater pressures whose limitation is given by the container's pressure design and is contemplated within the scope of the invention.

The liquid saturated with carbon dioxide, which contains the dissolved calcium salt is suddenly depressurized through a nozzle (N) with a length to diameter ratio between 5 and 80, and a diameter between 50 and 150μm in a collection container (SV). Given that CO2 evaporates during the expansion, the density of the solution changes causing a very high super-saturation of the solution during a very short period of time, avoiding significant growth of the particles. Depressurization is carried out by bearing in mind that both pre-expansion pressure and temperature (i.e., just before the nozzle) must be kept constant and near the values of solubility conditions.

Thus, we obtain a calcium-reinforced aqueous liquid with particle sizes quite below 10 μm, whose values depend on the conditions employed in the depressurization.

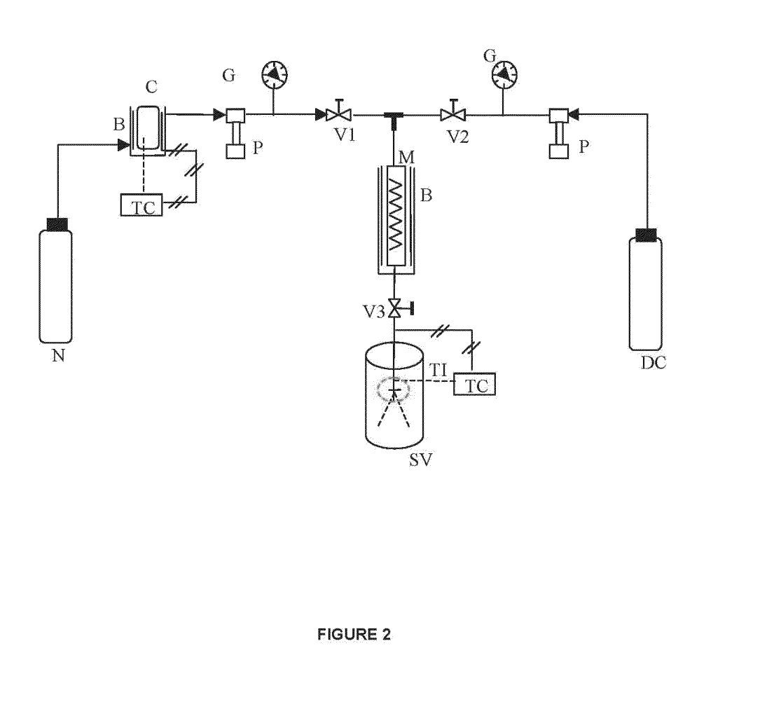

FIG. 2 shows a schematic representation of the invention process developed continually, where a calcium salt suspension in the liquid to be reinforced with calcium is loaded onto a storage container (C) coated (B) to keep the temperature constant (TC) (for example, 15° C.). The container contents are kept agitated and pressurized with nitrogen gas (N) or another gas to guarantee a constant head on a first high-pressure pump (P).

Once container temperature is constant, pumping of the carbon dioxide (DC) and the suspension is begun using the first and second high-pressure pumps (P), and keeping valves (V1 and V2) closed until reaching the desired pressure, for example 6,62 MPa. To keep carbon dioxide temperature constant, this can be transferred through a coil immersed in an isothermal bath (not shown in the figure).

When reaching the desired pressure, valves (V1 and V2) are opened to maintain the pressure and for the flow to be constant. The carbon dioxide (DC) and calcium suspension are mixed in a Tee that leads to a jacketed (B) static mixer (M). The flow of both fluids and the length of the static mixer are calculated to guarantee sufficient time of residence to solubilize the calcium in suspension.

Depressurization of the solution saturated with carbon dioxide takes place upstream from valve (V3) through a nozzle with a length to diameter ratio between 5 and 80, and diameter between 50 and 150 μm. The calcium reinforced liquid is finally collected in a container (SV). Depressurization is carried out by bearing in mind that both pre-expansion pressure and temperature (i.e., just before the nozzle) must be kept constant and near the values of solubility conditions through monitoring with one or more manometers (G) and a thermocouple (TI).

In a second object, the invention offers a method to incorporate calcium salts with particle size below 10 μm in water, carbonated beverages, juices, lacteous beverages, soups, or any other types of nutritional, nutraceutical, or pharmaceutical beverages without altering their appearance and flavor, guaranteeing at the same time the stability of the beverage, without precipitation of solids, for at least two months of storage at temperatures ranging from 7° C. to 32° C. Said method comprises the stages of:

a) Add compressed carbon dioxide in subcritical, critical, or supercritical state to a carbonated beverage, juice, lacteous beverage, water, soup, or any other types of nutritional, nutraceutical, or pharmaceutical beverages containing one or more calcium salts with particle size above 30 μm in a container at a pressure between 6.8 and 122.4 atmospheres and temperature between 10 and 40° C. for a period of time varying between 0.5 and 2 hours.

b) Transfer the compressed solution through a nozzle with a diameter between 50 and 150 μm and length between 0.25 and 6 mm, where the depressurization generates micro or nanoparticles of the calcium salt in suspension in the beverage. Where said decompression is carried out at constant temperature and pressure and equal to the solubility conditions to avoid possible precipitations of the particles and the consequent clogging of the nozzle.

The beverages obtained according to the method of the invention conserve the organoleptic properties (color, odor, and flavor) of the original not enriched beverage. The amount of calcium in suspension incorporated in the beverage corresponds to the calcium salt solubility in the liquid under saturation conditions with carbon dioxide, which can be up to 200 times the value of the solubility at room temperature and atmospheric pressure. From the tests conducted, it was established that without incorporating stabilizers (suspensors, emulsifiers, etc.) different beverages reinforced with calcium are stable for at least three months at temperatures varying between 7° C. and 32° C.

### EXAMPLE 1

In a first example, illustrating the invention and using the schematic representation of the process shown in FIG. 1, aqueous calcium citrate suspensions were used with 1.1 and 1.6 mg/ml concentrations, respectively. These concentrations are above that of citrate solubility in water at 25° C. and atmospheric pressure of 0.85 mg/ml. Then, carbon dioxide was introduced, the pressure was increased, and the value at which citrate was completely solubilized was registered (minimum solubility pressure). After a period of stabilization of the system, solubility conditions of the salt were registered like pressure and temperature at which the calcium salt particles are not optically detectable.

Table 1 shows the solubility conditions of calcium citrate. It should be highlighted that in this case the load of the calcium salt in the aqueous solution saturated with carbon dioxide is twice the solubility reported at 25° C. and 1 atm.

TABLE 1
Solubility conditions of calcium citrate

| | Temperature | Minimum solubility |
|---|---|---|
| Concentration (g/l) | (° C.) | pressure (psig) |
| 1.1 | 15.0 | 200 |
| 1.1 | 22.5 | 490 |
| 1.6 | 22.5 | 520 |
| 1.6 | 44.7 | 960 |

### EXAMPLE 2

Calcium citrate aqueous suspensions with concentrations of 1.1 and 1.6 mg/ml, respectively, were completely solubilized as described in Example 1, and were suddenly depressurized through a nozzle 80 μm in diameter and 1 mm in length (L/D=12.5), according to the process shown in FIG. 1. The depressurization was performed by keeping pre-expansion pressure and temperature constant at values close to solubility conditions.

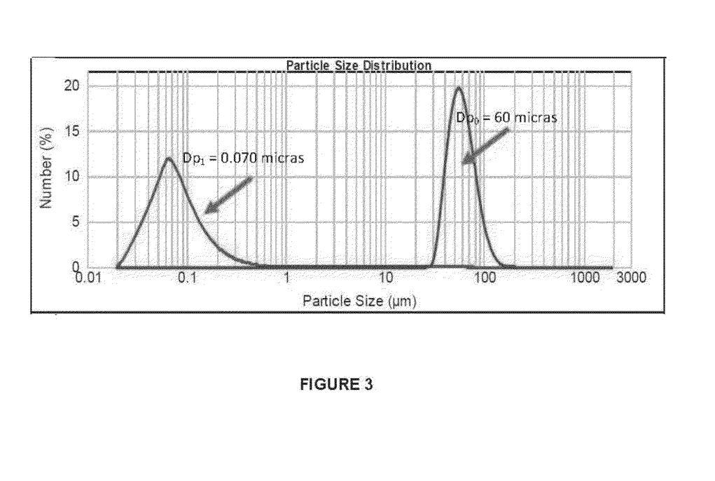

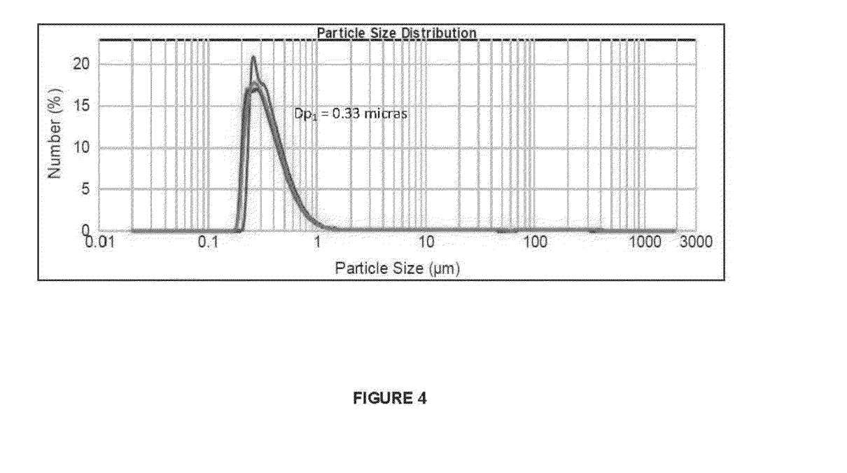

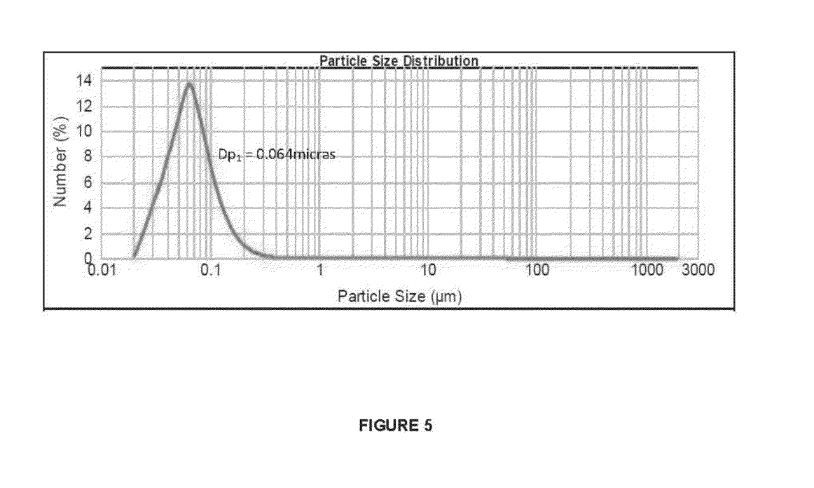

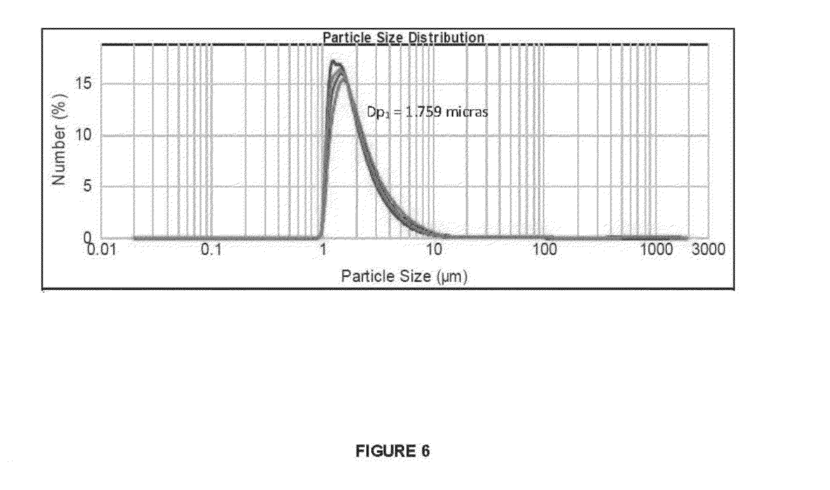

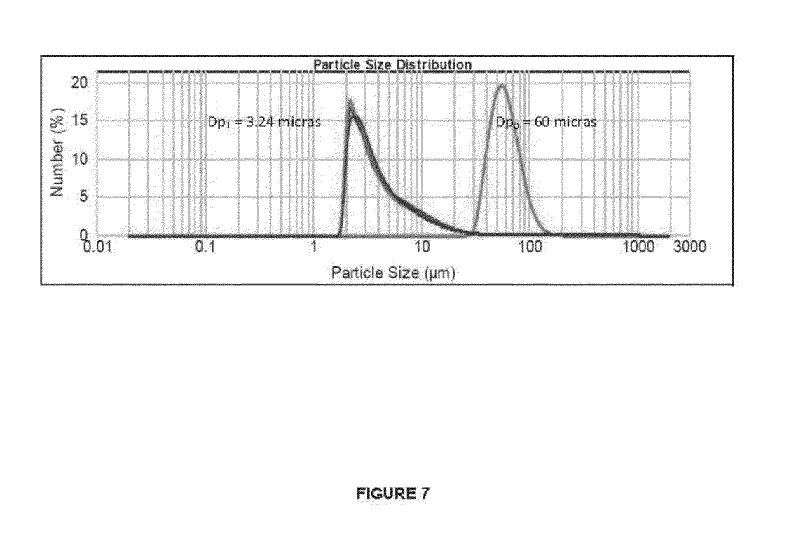

We obtained aqueous suspensions containing calcium citrate with particle sizes much smaller than the original size of the salt (average diameter of particles (Ad): 60μm), and whose values changed with the depressurization conditions used. FIGS. 3 to 7 show the distributions of the particle sizes for suspensions obtained via different experiments. FIG. 3 shows the decrease of particle size from a suspension at 1.1 mg/ml concentration of calcium citrate (Ad of the nutrient=60 μm) under depressurization conditions: 15° C. and 750 psig (Ad of the treated product=0.070 μm). FIGS. 4, 5, and 6 present the average particle size distribution (Ad) of the suspension at 1.1 mg/ml concentration of calcium citrate, after varying depressurization conditions: 22.5° C. and 750 psig (Ad of the treated product=0.33μm); 30° C. and 900 psig (Ad of the treated product=0.064μm); 30° C. and 900 psig (Ad of the treated product=1.759 μm), respectively. FIG. 7 shows the decrease in particle size of a suspension at 1.6 mg/ml concentration of calcium citrate (Ad of the nutrient=60μm) under depressurization conditions: 22.5° C. and 750 psig (Ad of the treated product=3.24μm).

In all cases, we obtained completely clear and transparent liquids, which did not reveal to the human eye the presence of suspension particles and which did not have odor or taste different to water.

### EXAMPLE 3

Using the schematic representation of the process shown in FIG. 1, we used aqueous suspensions of calcium carbonate, with concentrations from 1.1 to 2.2 mg/ml, respectively. It should be noted that these concentrations are well above the solubility of calcium carbonate in water at 25° C. and atmospheric pressure of 0.012 mg/ml. Then, we introduced carbon dioxide, increased pressure, and registered the value at which the carbonate was completely solubilized, as the minimum solubility pressure.

Table 2 shows the solubility conditions for calcium carbonate. Note that in this case the load of the calcium salt in the aqueous solution saturated with carbon dioxide is up to 180 times the solubility reported at 25° C. and 1 atm.

TABLE 2
Solubility conditions of calcium carbonate

| | Temperature | Minimum solubility |
|---|---|---|
| Concentration (g/l) | (° C.) | pressure (psig) |
| 1.1 | 15.0 | 260 |
| 1.1 | 22.5 | 350 |
| 1.6 | 22.4 | 400 |
| 1.6 | 45.8 | 900 |
| 2.2 | 15.0 | 550 |
| 2.2 | 30.3 | 1250 |

The expansion of the pressurized solution through a nozzle according to guidelines described in Example 2 produced calcium carbonate particles whose average particle diameter was between 0.65 and 2.0 μm.

### EXAMPLE 4

According to the invention, liquids reinforced with calcium salt are stable even without adding stabilizers; said liquids are characterized by the lack of solid precipitates after more than two (2) months of storage at temperatures ranging from 7° C. to 32° C. Table 3 shows storage temperature and time of some samples of water reinforced with calcium salts, in which there was no notable destabilization of the suspension at any time during storage.

TABLE 3
Storage temperature and time of water reinforced with
calcium salts, without destabilizing the suspension.

| | Concen- | Solubility | Storage | Time of |
|---|---|---|---|---|
| | tration | Temperature | Temperature | storage |
| Calcium salt | (g/l) | (° C.) | (° C.) | (months) |
| Citrate | 1.3 | 30.0 | 6 | 3.5 |
| Citrate | 1.5 | 45.0 | 6 | 3.0 |
| Carbonate | 1.6 | 45.0 | 6 | 5.0 |
| Carbonate | 1.1 | 30.0 | 32 | 17.0 |

Although the present invention has been described with the preferred embodiments shown, it remains that the modifications and variations conserving the spirit and scope of this invention like different calcium salts and nutritional, pharmaceutical, or nutraceutical beverages are understood within the reach of the claims attached.

1-7. (canceled)

8. A process to prepare an aqueous suspension of calcium salt particles with particle size below 10 μm comprising the stages of:
a) adding compressed carbon dioxide in subcritical, critical, or supercritical state to a calcium salt suspension in a container at pressure between 6.8 and 122.4 atmospheres and temperature between 10 and 40° C. for a time ranging between 0.5 and 2 hours; and
b) passing the compressed solution through a nozzle between 50 and 150 μm in diameter and 0.25 to 6 mm long, wherein a ratio between length and diameter is between 5 and 80, to generate the salt precipitation in the aqueous medium.

9. The process to prepare an aqueous suspension of a calcium salt of claim 8, further compromising employing the carbon dioxide in stage a) to diminish the pH of the water and increase the solubility of the calcium salt in water.

10. The process to prepare an aqueous suspension of a calcium salt of claim 8, further comprising increasing the pressure to ensure the complete solubility of said salt after the salt solubilisation is reached in stage a.

11. The process to prepare an aqueous suspension of a calcium salt of claim 8, further comprising in stage b) producing a sudden expansion of the calcium solution saturated with carbon dioxide to generate calcium micro- or nano-particles in suspension.

12. The process to prepare an aqueous suspension of a calcium salt of claim 8, wherein the passing in stage b) is carried out at a constant temperature and pressure and equal to the solubilization conditions in stage a).

13. A method to incorporate calcium salts with particle size below 10 μm in water, carbonated beverages, juices, dairy drinks, soups, or any other types of nutritional, nutraceutical, or pharmaceutical beverages by increasing the calcium salt solubility in the beverage up to 200 times the value of the solubility at room temperature and atmospheric pressure comprising the stages of:
a) adding compressed carbon dioxide in sub-critical, critical, or super-critical state to a beverage that contains one or more calcium salts with particle size above 30 μm in a container at pressure between 6.8 and 122.4 atmospheres and temperature between 10 and 40° C. for a time ranging between 0.5 and 2 hours; and
b) suddenly passing the compressed solution through a nozzle between 50 and 150 μm in diameter and 0.25 to 6 mm long, to depressurize the solution at constant temperature and pressure which are equal to the solubilization conditions from stage a) to generate calcium salt micro- or nano-particles in suspension in the beverage.

14. The method to incorporate calcium salts with particle size below 10 μm in water, carbonated beverages, juices, dairy drinks, soups, or any other types of nutritional, nutraceutical, or pharmaceutical beverages of claim 13, wherein the resulting calcium salt suspension does not present precipitation of solids for at least two months of storage at temperatures above 10° C. and conserves the organoleptic properties of the original beverage.
